(19) United States
(12) Patent Application Publication
(10) Pub. No.: US 2008/0072830 A1
(43) Pub. Date: Mar. 27, 2008

(54) Ant proof pet bowl

(76) Inventor: William P. Wrigge, Fredericksbrg, TX (US)

Correspondence Address: Ted D. Lee, Suite 1500, 700 N. St. Mary's Street, San Antonio, TX, 78205, US

(21) Appl. No.: 11/518,135

(22) Filed: Sep. 8, 2006

(51) Int. Cl. A01K 5/01

(52) U.S. Cl. 119/61.53

(57) ABSTRACT

An ant proof pet feeding bowl as shown with two bowls having an annular moat there between. The first bowl has a first cylindrical lower portion with an outward flare before a first cylindrical upper portion. The second bowl has a second cylindrical lower portion that receives the first bowl in a fitting relationship therein. The second bowl has a larger second cylindrical upper portion that provides an annular space between the second bowl and the first bowl. The annular space is filled with a liquid to keep ants from getting to the food contained inside of the first bowl.

### BACKGROUND OF THE INVENTION

1. Field of the Invention

The present invention relates to feeding dishes for pets and, more particularly, to an ant proof feeding dish used primarily for dogs and cats.

2. Prior Art

Just as dishes used by humans have evolved from the crude wooden bowls, so have the feeding dishes for pets evolved. The customary pet feeding dish is a bowl placed on either the floor or ground in which food or water is placed for the pet. This is particularly true for the most common household pets, namely cats or dogs. However, the placing of the pet feeding bowl on the floor or ground normally results in insects or bugs, particularly ants, invading the feeding bowl to get to the food contained within the bowl. If the pet is being fed inside the house, this may result in a trail of ants going to the pet feeding bowl, not to mention roaches or other undesirable insects.

Across the southern part of the United States, there has been a fire ant infestation. Leaving out open pet food, even in a pet feeding bowl, can result in fire ants going to the pet food. If the pet is being fed inside the house, this can result in fire ants being attracted to the pet feeding bowl, especially if pet food remains in the pet feeding bowl.

Various types of prior devices have been developed to try and reduce the problem. For example, Sebastin et al (U.S. Pat. No. 5,577,461) shows a pet food dish having a moat thereround, but also has a liquid receptacle portion as well as the cylindrical portions and a food liner. The invention as shown in Sebastin et al. does not have the ease and simplicity of making as the present invention.

Phillips (U.S. Pat. No. 5,031,575) shows a u-shape configuration for a base in which water or some other liquid may be poured. The food bowl has locking ribs to lock into place with mating ribs. Due to the overlapping nature of the configuration as shown in Phillips, it cannot be made with two part dye castings as the present invention. Phillips would be much more complicated to make then the present invention.

Two somewhat similar configurations to the present invention are Welch et al. (U.S. Pat. No. 4,803,954) and Faeroe (U.S. Pat. No. 4,981,108). Both of these are more complicated to make than the present invention. Welch uses some type of biodegradable substance to prevent insects from getting to the food. Faeroe shows a moat type of configuration, but again is more expensive to manufacture that the present invention.

Other more complicated pet food dishes that are designed to keep insects out of the bowls are Ahuna (U.S. Pat. No. 5,069,166), Kasselman (U.S. Pat. No. 5,205,242), Walker (U.S. Pat. No. 5,619,952), Breedwell (U.S. Pat. No. 6,125,790) and Trampier, Sr. (U.S. Pat. No. 2,191,811). However, none of these inventions have the simplicity and ease of manufacturing as the present invention. It is very important to have an inexpensively manufactured pet food bowl that will keep out ants and other crawling insects, while at the same time providing a sanitary receptacle for the pet food. In particular, a need exists for a pet feeding bowl that would prevent ants and small crawling insects from getting into the food, yet at the same time be simple to manufacture and clean.

### SUMMARY OF THE INVENTION

Accordingly, it is an object of the present invention to provide an improved pet food bowl that is cheap to manufacture and easy to clean.

It is another object of the present invention to provide a pet food bowl that deters ants and other insects from getting to the pet food.

It is yet another object of the present invention to provide a pet food bowl that may be dye cast with two part dyes.

It is still another object of the present invention to have the moat between a first bowl and a second bowl so that the moat may be filled with water, or some other hand substance, to prevent crawling insects from getting to pet food contained on the inside thereof.

It is yet another object of the present invention to have a first bowl with a first cylindrical lower portion and a first cylindrical upper portion. A second bowl has a second cylindrical lower portion that fits within the first cylindrical lower portion of the first bowl. A moat for a fluid is provided between a second cylindrical upper portion of the second bowl and the first cylindrical lower portion of the first bowl. Water, or some other suitable liquid substance, can be put in the moat to keep ants or other crawling insects from getting from the second bowl to the first bowl which contains the pet food. The liquid in the moat provides a barrier to access by ants or crawling insects to the pet food.

### BRIEF DESCRIPTION OF THE DRAWINGS

FIG. 1 is a perspective view of the present invention.

FIG. 2 is an exploded perspective view of the present invention.

FIG. 3 is a top plan view of the present invention.

FIG. 4 is a cross sectional view of FIG. 3 taken along section lines 4-4.

### DETAILED DESCRIPTION OF THE PREFERRED EMBODIMENT

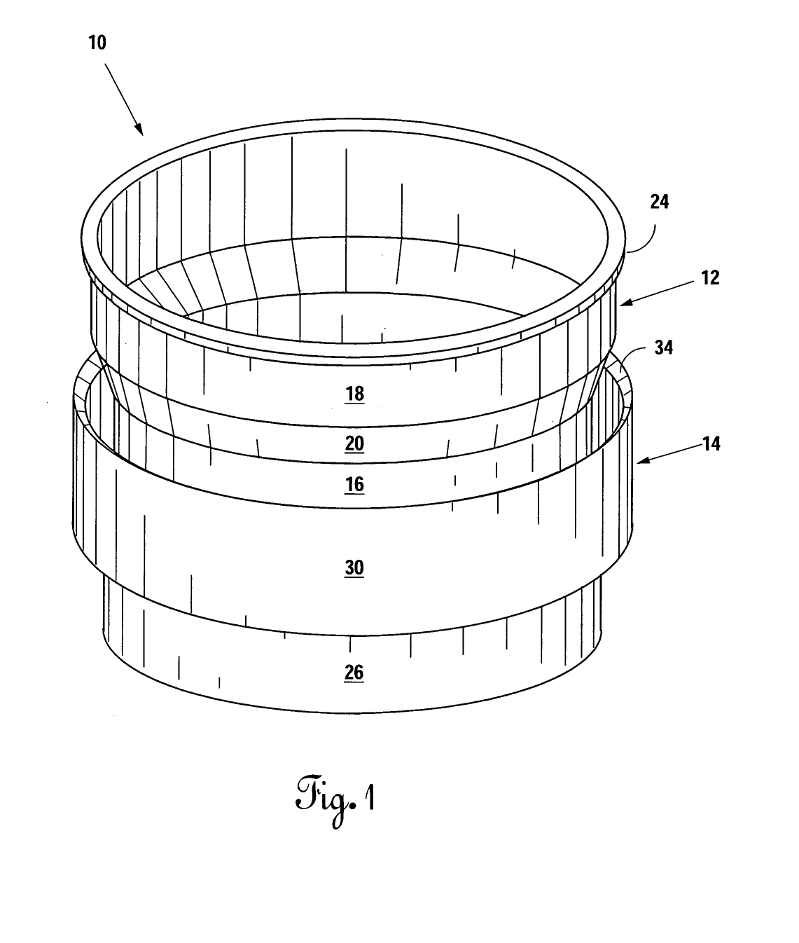

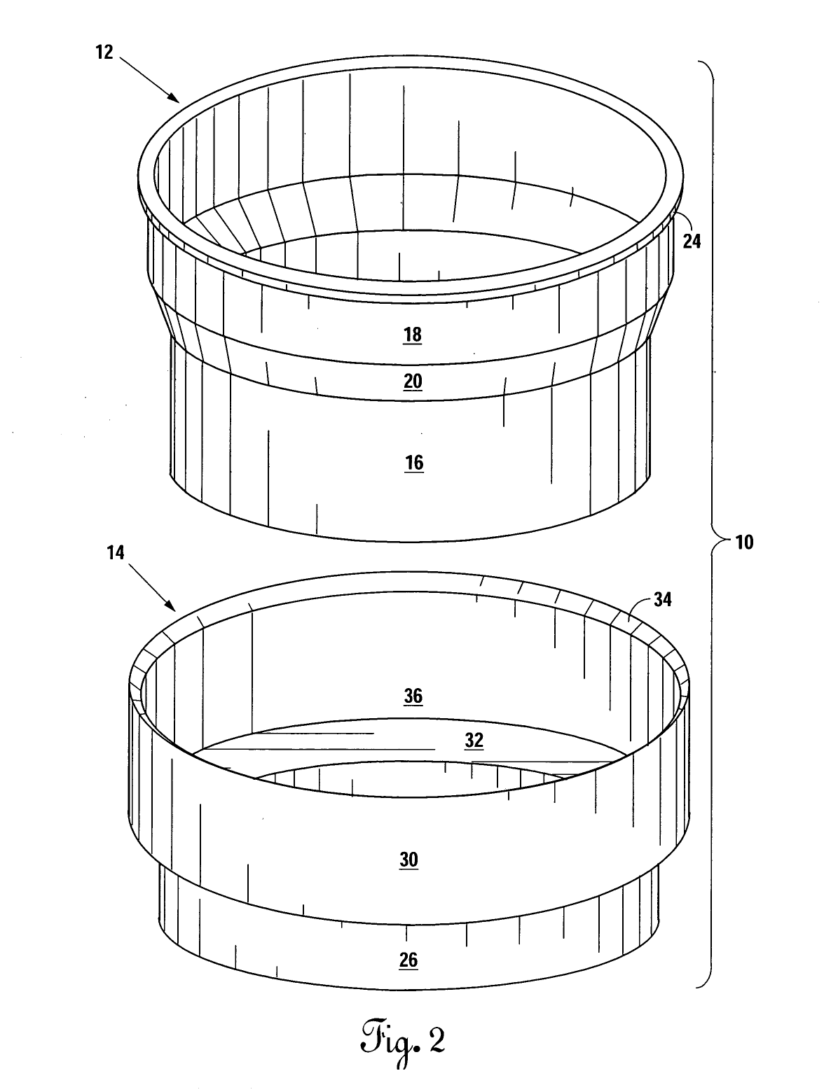

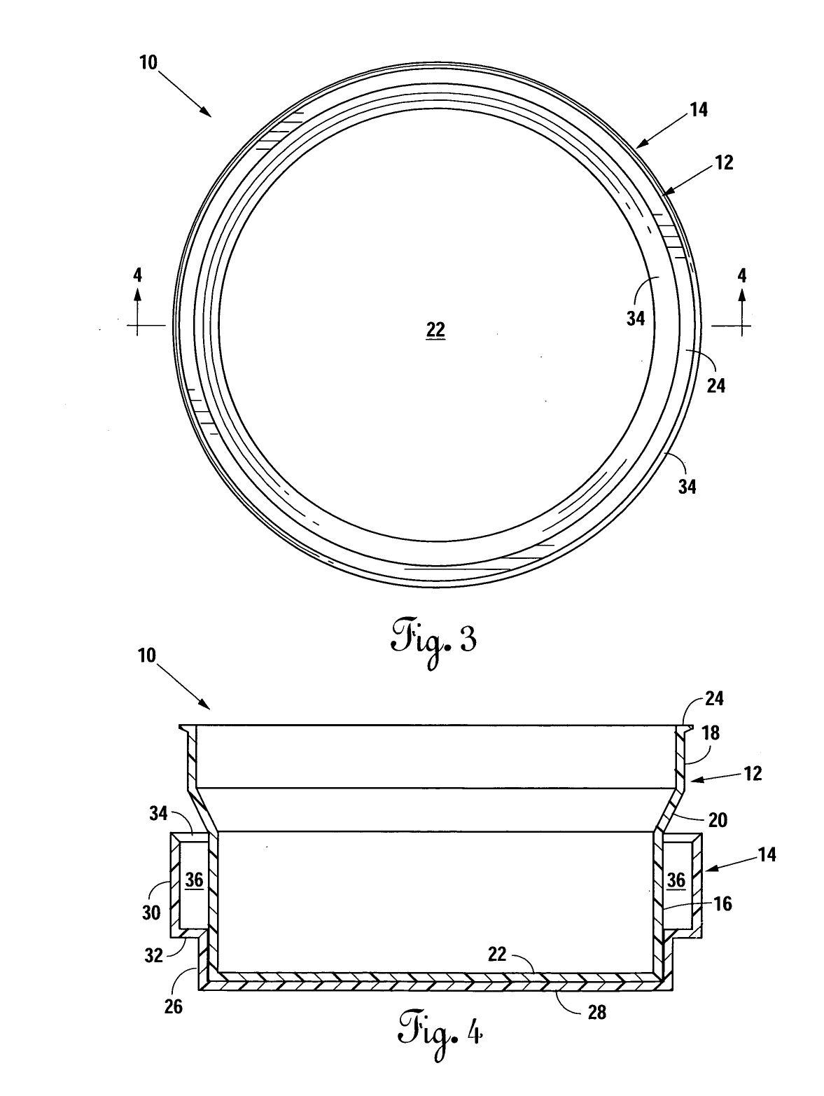

Referring now to FIGS. 1, 2, 3 and 4 in combination, the pet feeding bowl is referred to generally by reference numeral 10. The pet feeding bowl 10 has a first bowl 12 and a second bowl 14. The first bowl 12 has a first cylindrical lower portion 16 and a first cylindrical upper portion 18 separated by outward flare 20. A first bottom 22 closes the lower end of first cylindrical portion 16 of first bowl 12. The upper end of the first cylindrical upper portion 18 has an outwardly extending upper lip 24 thereon.

The second bowl 14 has a second cylindrical lower portion 26 enclosed at the lower end thereof by a second bottom 28 (see FIG. 4). The second bowl 14 also has a second upper cylindrical portion 30 which connects with the second cylindrical lower portion 26 by outward flare 32 (see FIG. 4). The top of the second cylindrical upper portion 30 has an inward taper 34 thereon.

In actual use, the first bowl 12 is inserted inside of the second bowl 14. The outside diameter of the first cylindrical lower portion 16 of the first bowl 12 is small enough to fit in a mating relationship inside of the inside diameter of the second cylindrical lower portion 26 of the second bowl 14. An illustration of this fitting relationship is provided in FIG. 4. The tightness of the fit may vary anywhere from a loose fitting relationship, to a snug fit, to having a bonding agent such as glue holding the first bowl 12 inside of the second bowl 14. If the first 12 is seperatable from the second bowl 14, it would be easier to clean the moat 36 (see FIG. 4) located between the first bowl 12 and the second bowl 14. However, some pet owners would prefer a one piece pet food bowl 10 over ease of cleaning. Therefore, the first bowl 12 and second bowl 14 may, or may not, be bonded together.

In this preferred embodiment, the moat 36 will be filled with a suitable liquid such as water, soapy water or any other substance not harmful to the pet to keep fire ants or other crawling insects from swimming the moat 36 to get to the first bowl 12 containing the pet food therein. In the normal use, the pet owner will fill the moat 36 with the preferred liquid to keep the fire ants or crawling insects from reaching the first bowl 12. Thereafter, the pet food would be placed inside of the first bowl 12.

By use of the pet feeding bowl 10, the pet owner could place pet food inside of the first bowl 12 and have the pet feeding bowl 10 located on the floor inside of the house. Because the moat 36 between the first bowl 12 and the second bowl 14 will keep crawling insects and ants from reaching the pet food, the pet food will not attract insects. Particularly, ants will not make a trail to the pet food because the ants cannot get to the pet food due to a liquid filled moat 36. Thereafter, if the pet owner wants to clean the pet feeding bowl 10, they may either clean the first and second bowl separately, or clean the pet feeding bowl 10 with the first bowl 12 and the second bowl 14 being connected together.

The pet feeding bowl 10 as just described is very simple to manufacture. The first bowl 12 and the second bowl 14 can both be made by two part injection molding because there are no hidden surfaces. Two part injection molding is the cheapest way of making the pet feeding bowl and is very economical to manufacture.

1. An ant proof pet feeding bowl for feeding pet food to pets therefrom, said ant proof feeding bowl comprising:
a first bowl having a first cylindrical lower portion with a predetermined outer diameter and an outwardly flaring first cylindrical upper portion;
a second bowl having a second cylindrical lower portion with a predetermined inner diameter slightly larger than said predetermined outer diameter of said first bowl to receive said first bowl in a fitting relationship therein, said second bowl having a second cylindrical upper portion of a larger internal diameter than said predetermined outer diameter of said first bowl to form an annular space therebetween;
said second bowl being shorter in height than said first bowl so that pet food placed in said first bowl is protected from ants by a liquid in said annular space.

2. The ant proof pet feeding bowl as recited in claim 1 wherein said outwardly flaring first upper cylindrical portion of said first bowl is above an upper end of said second cylindrical upper portion of said second bowl to allow access to said annular space.

3. The ant proof pet feeding bowl as recited in claim 2 wherein said first bowl is secured in said fitting relationship with said second bowl.

4. The ant proof pet feeding bowl as recited in claim 3 wherein said securing is by bonding.

5. The ant proof pet feeding bowl as recited in claim 4 wherein said outwardly flaring first cylindrical upper portion has an outwardly extending lip thereon.
